(19) United States
(12) Patent Application Publication
(10) Pub. No.: US 2007/0057572 A1
(43) Pub. Date: Mar. 15, 2007

(54) Hydraulic vehicle brake equipped with a parking brake device and method for its operation

(75) Inventors: Axel Hinz, Neu-Anspach (DE); Gunther Vogel, Dreieich (DE); Uwe Greiff, Bad Homburg (DE); Rene Lenz, Frankfurt am Main (DE); Christoph Kohler, Kelkheim (DE)

Correspondence Address: CONTINENTAL TEVES, INC., ONE CONTINENTAL DRIVE, AUBURN HILLLS, MI, 48326-1581, US

(73) Assignee: Continental Teves AG & Co., oHG

(21) Appl. No.: 11/506,003

(22) Filed: Aug. 17, 2006

(30) Foreign Application Priority Data
Sep. 15, 2005 (DE) 10 2005 043 976.4
Dec. 21, 2005 (DE) 102005061352.7

(51) Int. Cl. B60T 8/36

(52) U.S. Cl. 303/119.2

(57) ABSTRACT

An electromagnetic valve includes a non-return valve (1) in a bypass connection for bypassing two valve closure members (16, 17) in their closed switch position, for what purpose the non-return return valve (1) is arranged outside the valve housing (2) in an annular member (3), which is arranged fluid-tightly in the area of the pressure fluid outlet (4) between a valve-accommodating bore (5) and the valve housing (2).

### BACKGROUND OF THE INVENTION

The present invention relates to an electromagnetic valve for slip-controlled motor vehicle brake systems Electromagnetic valve for slip-controlled motor vehicle brake systems, comprising a first and a second valve closure member arranged in a valve housing, being placed in coaxial arrangement in the valve housing and adapted to open or close a first and a second valve gate, comprising a pressure fluid inlet that opens into the valve housing and a pressure fluid outlet, with the first valve closure member being able to open or close the first valve gate positioned in the second valve closure member depending on the electromagnetic energization of a valve coil, while the second valve closure member, under the influence of a spring, opens the second valve gate exclusively in the open position of the first valve gate so that pressure fluid prevailing in the pressure fluid inlet propagates along a flow conduit inside the valve housing, in which the first and the second valve gates are disposed, to the pressure fluid outlet, and comprising a non-return valve in a bypass connection for bypassing the two valve closure members in their closed switch position.

German patent application DE 198 36 493 A1 discloses an electromagnetic valve of the type indicated for a slip-controlled brake system which comprises a non-return valve integrated in a valve piston for establishing a bypass connection to bypass the valve in the closed switch position of the valve for bleeding and filling purposes. Due to the miniaturization of the valve piston, the integration of the non-return valve in the valve piston necessitates a correspondingly great effort of manufacture.

In view of the above, an object of the invention relates to improving an electromagnetic valve of the type mentioned hereinabove with functionally suitable means being as simple as possible in such a manner as to avoid integration of the non-return valve in the valve piston, while maintaining the above-mentioned bypass function.

According to the invention, this object is achieved in that the non-return valve is arranged outside the valve housing in an annular member which is arranged fluid-tightly in the area of the pressure fluid outlet between a valve-accommodating bore and the valve housing.

Further features, advantages, and possible applications of the invention can be taken in the following from the description of several embodiments.

### BRIEF DESCRIPTION OF THE DRAWINGS

In the drawings,

FIG. 1 is a total longitudinal cross-sectional view of a two-stage electromagnetic valve as known from the state of the art, which shall be provided with an appropriate bypass function according to the invention;

FIG. 2 shows an enlarged view of the bottom portion of the electromagnetic valve of FIG. 1 in a constructive modification which is essential for the invention, to what end a non-return valve is incorporated in an annular member;

FIG. 3 is an alternative design and arrangement of the annular member of the invention at the electromagnetic valve of FIG. 1.

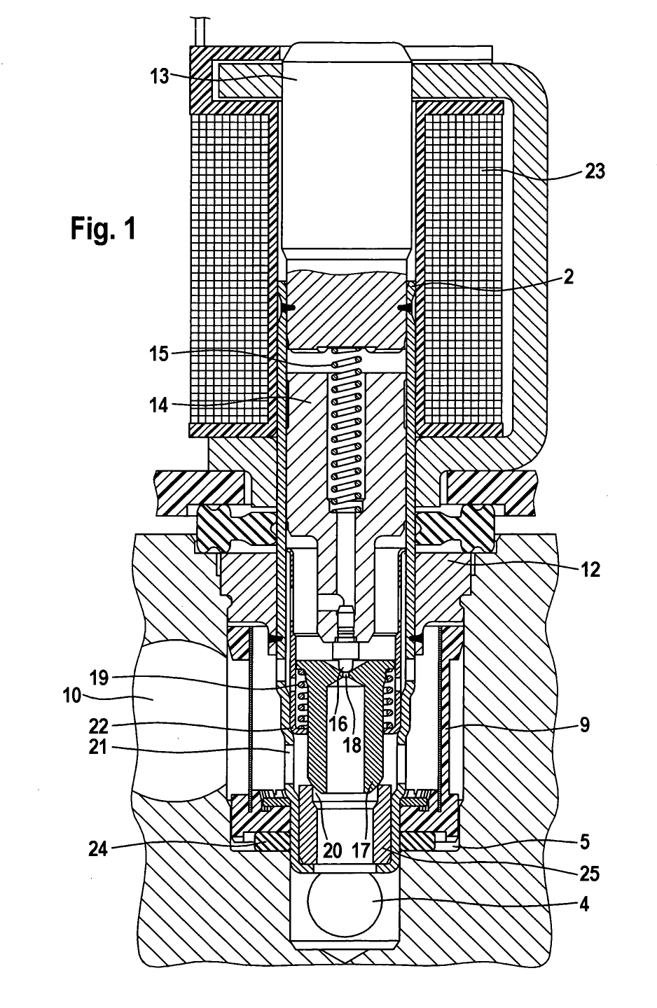

FIG. 1 shows in a considerably enlarged, longitudinal cross-sectional view an electromagnetic valve with a one-part, deep-drawn, thin-walled valve housing 2, which accommodates a separate holding collar 12, mounted on the outside periphery of the valve housing and secured in a laser welding process, the said holding collar being made by non-cutting shaping, e.g. as a cold impact forging part. The basically disc-shaped holding collar 12 at the outside periphery is configured as a calking punch, allowing it with its circumferential undercut along with the ready-made valve housing 1 to be press-fitted into a stepped valve-accommodating bore 5 of a block-shaped valve carrier, the soft material of which displaces into the undercut during the press-fit operation for fastening and sealing purposes. Above the holding collar 12, the open end portion of the sleeve-shaped valve housing 2 is closed by a plug 13, which assumes the function of a magnet core in addition. Likewise the plug 13 is a low-cost cold impact forging part, which is manufactured with appropriate precision and laser-welded at the outside periphery with the valve housing 2. Below the plug 13, there is an armature 14 that is made of a round or many-sided profile in a cold impact forging or extrusion process in a likewise very inexpensive manner. By the action of a compression spring 15, the armature 14 closes a first valve gate 18 arranged in a second valve closure member 17 in the basic position of the valve, said closing being done by way of a first valve member 16 arranged at the tappet-shaped extension of the armature 14. To this end, the first valve closure member 16 is expediently fitted as half a ball at the tappet portion, which is secured by means of self-calking in a bore of the armature 14, while the second valve closure member 17 is basically designed as a piston-shaped turned part which is acted upon by the action of a spring 19 in the direction of the first valve closure member 16.

Due to the effect of the compression spring 15 arranged between the plug 13 and the armature 14, the bottom of the valve closure member 17 acting as valve closing means will remain in the valve's basic position on a valve seat member 25, which is provided in the lower end of the valve housing 2, as illustrated. The cross-section of passage of the valve seat member 25, which can be switched to open depending on the hydraulic differential pressure, is considerably larger than the opening cross-section of the first valve gate 18 disposed in the second valve member 17, which can be opened electromagnetically.

The pressure fluid inlet 10, which is basically illustrated as a transverse channel in the valve carrier 4, continues via the annular filter element 9 disposed in the hollow space of the valve carrier to the punched transverse bore 21 in the valve housing 2, so that inlet-side pressure fluid is applied directly to the second valve closure member 17.

Spring 19 is disposed outside the flow conduit that can connect the pressure fluid inlet 10 to the pressure fluid outlet 4, to what end a sleeve-shaped stop member 22 for the spring 19 is inserted into the valve housing 2, and the end of the spring 19 remote from the second valve closure member 17 is supported on the stop member. The sleeve portion of the stop member 22 guides and centers the second valve closure member 17 in the direction of the valve seat member 25 arranged at the lower end of the valve housing 2.

Thus, an electromagnetic valve is obtained, having a first and a second valve closure member 16, 17 adapted to open or close a first and a second valve gate 18, 20. The first valve closure member 16 is able to open or close the first valve gate 18 positioned in the second valve closure member 17 depending on the electromagnetic energization of a valve coil 23, while the second valve closure member 17, under the influence of the spring 19, opens the second valve gate 20 only in the open position of the first valve gate 18 so that pressure fluid prevailing in the pressure fluid inlet 10 propagates along a flow conduit inside the valve housing 2, in which the first and the second valve gates 18, 20 are disposed, to the pressure fluid outlet 4.

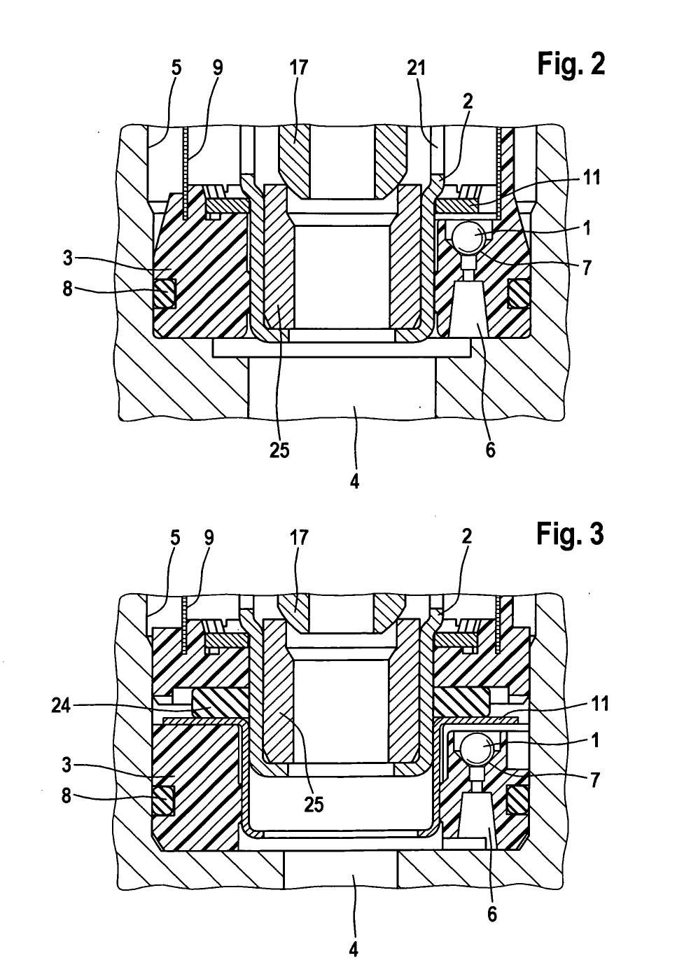

According to the features illustrated in FIGS. 2 and 3, which are essential for the invention, a bypass connection that is arranged outside the valve housing 2 in an annular member 3 houses a non-return valve 1 opening in the direction of the pressure fluid inlet 10 in order to bypass the two valve closure members 16, 17 in their closed switch position. To this end, the annular member 3 is arranged in the area of the pressure fluid outlet 4 in a fluid-tight fashion between a valve-accommodating bore 5 and the bottom end of the valve housing 2.

In conformity with the enlarged illustrations of the invention in FIGS. 2 and 3, a stepped bypass channel 6 extends eccentrically vertically through the annular member 3, and a valve seat 7 to accommodate and seal the non-return,valve 1 is arranged in said channel. To this effect, the valve seat 7 is preferably designed as a conical sealing seat, and the non-return valve 1 is designed as a spherical non-return valve.

In order to minimize the complexity of manufacture for the annular member 3, the valve seat 7, and the bypass channel 6 to the greatest extent possible, the annular member 3 is made of a viscous, wear-resistant plastic material in an injection-molding process. For sealing in the valve-accommodating bore 5, the annular member 3 includes a ring seal 8 at the outside periphery, which is received in an annular groove of the annular member 3. The inside periphery of the annular member 3 is provided with a press fit so that the annular member 3, prior to the installation of the electromagnetic valve in the valve-accommodating bore 5, is already press-fitted at the bottom sleeve end of the valve housing 2 in a pressure-fluid-tight manner.

In order that the valve seat 7 provided for the non-return valve 1 is devoid of radial forces which are active due to the press fit connection of the annular member 3 inserted between the valve housing 2 and the valve-accommodating bore 5, the annular member 3 is offset radially and axially in the area of the valve seat 7 in order to avoid mechanical stress at the valve seat 7, or it is decreased in sections in the inside diameter, and also in the outside diameter, when required. The radial forces, which are introduced into the annular member 3 due to the press fit connection, are exclusively introduced at defined locations via the contact surface of the annular member 3 that is operatively bearing against the valve housing 2 below the non-return valve 1.

In the embodiment of FIG. 2, an annular filter element 9 that is rigidly connected to the annular member 3 succeeds the end surface of the annular member 3 remote from the pressure fluid outlet 4, said filter element 9 covering the pressure fluid inlet 10 for filtering the fluid. Thus, the embodiment of FIG. 2 represents a suitable structural combination of the annular filter element 9 known from FIG. 1 with the annular member 3 that accommodates the non-return valve 1.

In order that the non-return valve 1 will always remain in the area of the valve seat 7, a stop washer 11 is secured to the end side of the annular member 3 remote from the pressure fluid outlet 4, said stop washer partly covering the non-return valve 1 inserted into the bypass channel 6 (see FIGS. 2 and 3).

The annular member 3 along with the non-return valve 1, the stop washer 11, and the annular filter element 9 forms an independently manageable subassembly, which is fastened as a pre-assembly unit in a simple fashion by means of a press fit connection at the bottom end of the sleeve-shaped valve housing 2.

FIG. 3 shows another design variant of the stop washer 11 which is shaped as a sheet-metal bowl with a fluid-permeable bowl bottom, the peripheral surface of which extends in a radially sealing manner between the valve housing 2 and the inside wall of the annular member 3. The annular member 3 in this arrangement is spaced by an elastomeric sealing washer 24 from the bowl-shaped annular filter element 9 that is known from FIG. 1. FIG. 3 thus represents an embodiment of the invention in which all valve components known from FIG. 1 can be maintained without modifications.

According to FIG. 2, the annular filter element 9 is conformed to the functional requirements of the non-return valve 1 and combined directly with the annular member 3, with the result of achieving a particularly compact mode of construction with a very small number of components.

FIGS. 2 and 3 illustrate the bypass passage within the valve seat 7 in each case as an orifice in order to prevent cavitation in the connected hydraulic system, in particular in the secondary circuit of a slip-controlled brake system, so that air is prevented from propagating into the hydraulic system through a possibly leaking piston seal of a return pump connected to the secondary circuit.

The risk of cavitation is encountered in the brake system due to a rapid release of the brake pedal. An appropriate pressure sensor system (wheel pressure, master cylinder pressure) allows detecting a brake pedal movement of this type in the hydraulic system and reducing a vacuum in the channel system, if desired or required, by electrically opening the electromagnetic valve that is known from FIG. 1. The electric opening of the electromagnetic valve may now be omitted due to the orifice effect of the bypass channel 6.

When the invention disclosed is implemented for a slip-controlled brake system, which is equipped with a driving dynamics control, automatic bleeding and automated filling of the secondary brake circuit can be carried out in a simple fashion, without the need to electrically actuate the electromagnetic valve.

List of Reference Numerals:
1 non-return valve
2 valve housing
3 annular member
4 pressure fluid outlet
5 valve-accommodating bore
6 bypass channel
7 valve seat
8 ring seal
9 annular filter element
10 pressure fluid inlet
11 stop washer
12 holding collar
13 plug
14 armature
15 compression spring
16 valve member
17 valve member
18 valve gate
19 spring
20 valve gate
21 transverse bore
22 stop member
23 valve coil
24 sealing washer
25 valve seat member

What is claimed is:

1. An electromagnetic valve for slip-controlled motor vehicle brake systems, comprising a first and a second valve closure member arranged in a valve housing, being placed in coaxial arrangement in the valve housing and adapted to open or close a first and a second valve gate, comprising a pressure fluid inlet that opens into the valve housing and a pressure fluid outlet, with the first valve closure member being able to open or close the first valve gate positioned in the second valve closure member depending on the electromagnetic energization of a valve coil, while the second valve closure member, under the influence of a spring, opens the second valve gate exclusively in the open position of the first valve gate so that pressure fluid prevailing in the pressure fluid inlet propagates along a flow conduit inside the valve housing, in which the first and the second valve gates are disposed, to the pressure fluid outlet, and comprising a non-return valve in a bypass connection for bypassing the two valve closure members in their closed switch position, wherein the non-return valve (1) is arranged outside the valve housing (2) in an annular member (3) which is arranged fluid-tightly in the area of the pressure fluid outlet (4) between a valve-accommodating bore (5) and the valve housing (2).

2. The electromagnetic valve as claimed in claim 1, wherein a bypass channel (6) in which a valve seat (7) for accommodating the non-return valve (1) is arranged, extends vertically through the annular member (3).

3. The electromagnetic valve as claimed in claim 2, wherein the valve seat (7) is designed as a conical sealing seat, and the non-return valve (1) is designed as a spherical non-return valve in the annular member (3).

4. The electromagnetic valve as claimed in claim 2, wherein the annular member (3), the valve seat (7), and the bypass channel (6) are manufactured of a viscous, wear-resistant plastic material, preferably in an injection molding process.

5. The electromagnetic valve as claimed in claim 2, wherein the valve seat (7) is devoid of radial forces, to what end the annular member (3) is radially offset in the area of the valve seat (7) to prevent radial stress at the valve seat (7), and/or is decreased in sections in the inside and outside diameters.

6. The electromagnetic valve as claimed in claim 1, wherein the annular member (3) includes a ring seal (8) at the outside periphery for sealing in the valve-accommodating bore (5).

7. The electromagnetic valve as claimed in claim 1, wherein an annular filter element (9) being rigidly connected to the annular member (3) extends at the front side of the annular member (3) remote from the pressure fluid outlet (4) and covers the pressure fluid inlet (10).

8. The electromagnetic valve as claimed in claim 7, wherein a stop washer (11), which partly covers the non-return valve (1), is secured to the front side of the annular member (3) remote from the pressure fluid outlet (4).

9. The electromagnetic valve as claimed in claim 8, wherein the annular member (3) along with the non-return valve (1), the stop washer (11), and the annular filter element (9) forms an independently manageable subassembly, which is fastened as a pre-assembly unit at the valve housing (2) by means of a press fit connection.

10. The electromagnetic valve as claimed in claim 8, wherein the stop washer (11) is shaped as a sheet-metal bowl with a fluid-permeable bowl bottom, the peripheral surface of which extends in a radially sealing manner between the valve housing (2) and the inside wall of the annular member (3).
